(19) United States
(12) Patent Application Publication
(10) Pub. No.: US 2011/0105369 A1
(43) Pub. Date: May 5, 2011

(54) WELL TREATMENT FLUIDS CONTAINING A VISCOELASTIC SURFACTANT AND A CROSS-LINKING AGENT COMPRISING A WATER-SOLUBLE TRANSITION METAL COMPLEX

(75) Inventor: B. Raghava Reddy, Duncan, OK (US)

(73) Assignee: Halliburton Energy Services, Inc.

(21) Appl. No.: 12/610,083

(22) Filed: Oct. 30, 2009

(51) Int. Cl. C09K 8/86

(52) U.S. Cl. 507/240; 507/260; 507/239; 507/261; 507/266; 507/244

(57) ABSTRACT

The invention is directed to methods for treating a portion of a well. The methods include the steps of: (A) forming a viscoelastic treatment fluid, wherein the treatment fluid comprises: (i) water; (ii) a viscoelastic surfactant (“VES”), wherein the VES is soluble in the water and wherein the VES is in the form of micelles; and (iii) a cross-linking agent for the VES molecules, wherein: (a) the cross-linking agent comprises cross-linking agent molecules having at least one complexed transition metal, wherein the transition metal has a valence state of at least three; and (b) the cross-linking agent is soluble in the water; and (B) introducing the treatment fluid into a portion of the well. According to a first aspect of the invention, (a) the VES comprises VES molecules having an alkyl group of greater than 14 carbon atoms and (b) the VES comprises VES molecules having at least one functional group selected from a carboxylate group, an amino group, an alcohol group, and an ether group. According to a second aspect of the invention, the VES comprises VES molecules having both an alkyl group of greater than 14 carbon atoms and at least one functional group selected from a carboxylate group, an amino group, an alcohol group, and an ether group.

### SUMMARY OF THE INVENTION

The field of the invention is treating wells for the purpose of producing oil or gas. More particularly, the invention provides methods for treating a portion of a well. The methods include the steps of: (A) forming a viscoelastic treatment fluid, wherein the treatment fluid comprises: (i) water; (ii) a viscoelastic surfactant (“VES”), wherein the VES is soluble in the water and wherein the VES is in the form of micelles; and (iii) a cross-linking agent for the VES micelles, wherein: (a) the cross-linking agent comprises cross-linking agent molecules having at least one complexed transition metal that has a valence state of at least three; and (b) the cross-linking agent is soluble in the water containing the VES micelles; and (B) introducing the treatment fluid into a portion of the well. According to a first aspect of the invention, (a) the VES comprises VES molecules having an alkyl group of greater than 14 carbon atoms and (b) the VES comprises VES molecules having at least one functional group selected from a carboxylate group, an amino group, an alcohol group, and an ether group. According to a second aspect of the invention, the VES comprises VES molecules having both an alkyl group of greater than 14 carbon atoms and at least one functional group selected from a carboxylate group, an amino group, an alcohol group, and an ether group.

### BRIEF DESCRIPTION OF THE DRAWING

The accompanying drawing is incorporated into the specification to help illustrate examples according to the presently most-preferred embodiment of the invention. The drawing is not to be construed as limiting the invention.

FIG. 1 is a graph of elastic modulus (G′) and loss modulus (G″) versus frequency for a control solution and a solution containing a zirconium ammonium lactate-acetate complex.

FIG. 2 is a graph of elastic modulus (G′) and loss modulus (G″) versus frequency for a control solution and a solution containing a zirconium triethanolamine glycolate complex.

FIG. 3 is a graph of elastic modulus (G′) and loss modulus (G″) versus frequency for a control solution and a solution containing a zirconium ammonium lactate-acetate complex that was reacted with TWEEN 60.

### DETAILED DESCRIPTION OF THE INVENTIONS

As used herein, the words “comprise,” “have,” “include,” and all grammatical variations thereof are each intended to have an open, non-limiting meaning that does not exclude additional elements or steps.

As used herein, a “fluid” is an amorphous substance having a continuous phase that tends to flow and to conform to the outline of its container (like a liquid or a gas) when tested at a temperature of 25° C. (77° F.) and a pressure of 1 atmosphere. A “fluid” can be homogenous or heterogeneous. For example, a “homogenous fluid” can contain dissolved components, such as salt. A “heterogeneous fluid” has a continuous phase and at least one discontinuous or dispersed phase. For example, a “heterogeneous fluid” can be or include a slurry or sol, which is a suspension of solid particles (such as sand) in a continuous liquid phase; it can be or include an emulsion, which is a dispersion of two or more immiscible liquids where droplets of at least one liquid phase are dispersed in a continuous liquid phase of another; or it can be or include a foam, which is a dispersion of gas bubbles in a continuous liquid phase. Further, as used herein, a “fluid” should be pumpable.

Oil and gas hydrocarbons are naturally occurring in some subterranean formations. Subterranean formations that contain oil or gas are called reservoirs. The reservoirs may be located under land or off-shore. Reservoirs are typically located in the range of a few hundred feet (shallow reservoirs) to a few tens of thousands of feet (ultra-deep reservoirs). In order to produce oil or gas, a well is drilled into a subterranean formation, which may be a reservoir or adjacent to a reservoir.

As used herein, a “well” includes at least one wellbore drilled into a subterranean formation. A wellbore can have vertical and horizontal portions, and it can be straight, curved, or branched. As used herein, the term “wellbore” refers to a wellbore itself, including any uncased, openhole portion of the wellbore. A near-wellbore region is the subterranean material and rock surrounding the wellbore. The near-wellbore region normally is considered the region within about 100 feet of the wellbore. As used herein, a “well” also includes the near-wellbore region. As used herein, “into a well” means and includes into any portion of the well, including into the wellbore or into the near-wellbore region via the wellbore.

As used herein, the words “treatment” and “treating” mean an effort used to resolve a condition of a well. Examples of treatments include, for example, stimulation, isolation, or control of reservoir gas or water.

Stimulation treatments fall into two main categories, hydraulic fracturing and matrix treatments. In a hydraulic fracturing treatment, a treatment fluid, sometimes called a fracturing fluid when adapted for this purpose is injected or pumped into a well at a pressure that is above the fracture pressure of the subterranean formation. The higher fluid pressure fractures the formation to create a flow path between the subterranean formation and the wellbore. Hydraulic fracturing is described in more detail below. In a matrix treatment, a treatment fluid is injected into a well at a pressure that is below the fracture pressure of the subterranean formation. The lower fluid pressure is sufficient to force the treatment fluid into the matrix of the subterranean formation but insufficient to fracture the subterranean formation.

Fracturing a subterranean formation typically requires many thousands of gallons of fracturing fluid. Further, it is often desirable to fracture at more than one downhole location of a well. Thus, a high volume of fracturing fluid usually is required to treat a well, which means that a low-cost fracturing fluid is desirable. Because of the ready availability and relative low cost of water compared to other fluids, a fracturing fluid is usually water-based. As used herein, a “water-based” fluid means a homogenous fluid of water or an aqueous solution or a heterogeneous fluid comprising water or an aqueous solution as the continuous phase.

After the pumping of the fracturing fluid is stopped, the fracture will tend to close. To prevent the fracture from closing, a material, called proppant, is placed in the fracture to keep the fracture propped open. Proppant is usually in the form of an insoluble particulate, which is suspended in the fracturing fluid, carried downhole, and deposited in the fracture. The proppant holds the fracture open while still allowing fluid flow through the permeability of the proppant. When deposited in the fracture, the proppant forms a “proppant pack,” and, while holding the fracture open, provides conductive channels through which fluids can flow towards the wellbore. These channels provide an additional flow path for the oil or gas to reach the wellbore, which increases oil and gas production from the well.

As used herein, “proppant” means and refers to an insoluble particulate material that is suitable for use as a proppant pack, including, without limitation, sand, synthetic materials, manufactured materials, and any combination thereof in any proportion. For this purpose, “proppant” does not mean or refer to suspended solids, silt, fines, or other types of insoluble particulate smaller than 0.0625 mm. Further, it does not mean or refer to insoluble particulates larger than 2 mm.

Suitable proppant materials include, but are not limited to, sand (silica), walnut shells, sintered bauxite, glass beads, plastics, nylons, resins, other synthetic materials, and ceramic materials. Mixtures of proppants can be used as well. If sand is used, it typically will be from about 20 to about 100 U.S. Standard Mesh in size. For a synthetic proppant, mesh sizes from about 8 to about 100 typically are used. The concentration of proppant in a fracturing fluid can be in any concentration known in the art, and preferably will be in the range of from about 0.01 kilograms to about 3 kilograms of proppant per liter of continuous liquid phase (about 0.1 lb/gal to 25 lb/gal).

An insoluble particulate also can be used for “gravel packing” operations. The insoluble particulate, when used for this purpose, is referred to as “gravel.” More particularly in the oil and gas field and as used herein, the term “gravel” is sometimes used to refer to relatively large insoluble particles in the sand size classification, that is, particles ranging in diameter from about 0.5 mm up to about 2 mm.

Proppant or gravel can have a different specific gravity than the homogenous treatment fluid or continuous phase of the treatment fluid. For example, sand (silica) has a specific gravity of about 2.7, whereas deionized water has a specific gravity of 1.0 (measured at 25° C. (77° F.) and 1 atmosphere pressure). Sand that is mixed with water will tend to settle out from the water. To help suspend a particulate, such as proppant or gravel, having a substantially different density than the treatment fluid, it is desirable to increase the viscoelasticity of the treatment fluid.

Viscoelasticity is the property of a material that exhibits both viscous and elastic characteristics when undergoing deformation. Viscous materials resist shear flow and strain linearly with time when a stress is applied to the material. Elastic materials strain instantaneously when a stress is applied and quickly return to the original state once the stress is removed. Measuring the viscoelasticity of a fluid can help determine the suspending capabilities of the fluid.

Viscoelasticity can be measured by swirling a fluid to create bubbles in the fluid and then visually observing whether the bubbles recoil after the swirling is stopped. If an air bubble suspended in the fluid recoils and comes back to its original position without moving to the air/fluid interface, then the fluid is considered to be viscoelastic.

Another way to determine the viscoelasticity of a fluid is to measure the elastic modulus and loss modulus of the fluid. Elastic modulus (G′) is a measure of the tendency of a substance to be deformed elastically (i.e., non-permanently) when a force is applied to it and returned to its normal shape. Elastic modulus is expressed in units of pressure, for example, Pa (Pascals) or dynes/cm². Loss modulus (G″) is a measure of the energy lost when a substance is deformed. G″ is also expressed in units of pressure, for example, Pa (Pascals) or dynes/cm². When comparing G′ to G″, the units of both G′ and G″ should be the same. The force normally is measured in rad/sec. If both G′>G″ and G′>1 Pa at at least one point over a range of points from about 0.001 rad/sec to about 10 rad/sec at a given temperature, then the fluid is considered to be viscoelastic at that temperature. A fluid is considered to be viscoelastic if at least one of the above tests is satisfied.

Some cross-linked polymers can be used to provide viscoelastic treatment fluids. A cross-linking agent can be used to cross-link the polymer molecules together. However, a disadvantage associated with viscoelastic treatment fluids that utilize cross-linked polymers is that the residue that is deposits on the fractured formation surfaces is often difficult to remove from the subterranean formation completely by the action of gel breakers. This often lowers the permeability of the fractured formation surfaces to hydrocarbon flow, thereby reducing the conductivity of fractured zones to hydrocarbons.

A viscoelastic surfactant (“VES”) can be used to provide a viscoelastic treatment fluid. The residue of a treatment fluid made with a VES is easier to remove from a subterranean formation compared to the residue of a treatment fluid made with a cross-linked polymer. A VES is made up of VES molecules. The VES molecules can be the same or different.

A surfactant molecule is amphiphilic. It comprises a hydrophobic tail group and a hydrophilic head group. The hydrophilic head can be charged. A cationic surfactant includes a positively-charged head. An anionic surfactant includes a negatively-charged head. A zwitterionic surfactant includes both a positively- and negatively-charged head. A surfactant that has a neutral charge is called a non-ionic surfactant.

If a surfactant is in a sufficient concentration in a solution, then the surfactant molecules can form micelles. A “micelle” is an aggregate of surfactant molecules dispersed in a solution. A micelle in an aqueous solution forms with the hydrophilic heads in contact with the surrounding aqueous solution, sequestering the hydrophobic tails in the micelle center. Conversely, a micelle in a non-aqueous solution forms with the hydrophobic tails in contact with the non-aqueous solution, sequestering the hydrophilic heads in the center of the micelle. The surfactant must be in a sufficient concentration to form a micelle, known as the critical micelle concentration. When the surfactant is in at least a sufficient concentration to spontaneously form micelles, then the surfactant is considered to be in the “critical micelle concentration.”

Micelles can form in various shapes. Non-viscoelastic surfactants form micelles that are generally round in shape, whereas a viscoelastic surfactant forms micelles that are generally worm- or rod-like in shape. VES micelles can provide viscoelastic properties to a fluid by becoming entangled with each other. This entanglement can be facilitated by the addition of salt to the fluid. It is now discovered that a viscoelastic fluid can be formed by forming and cross-linking VES micelles. One advantage of using cross-linked VES micelles instead of entangled VES micelles is that a lower concentration of VES can be used in the cross-linked system. In an embodiment, the viscosity and/or viscoelasticity of VES micelles can be improved by cross-linking pre-formed VES micelles. The elastic modulus can also be increased by cross-linking the VES micelles.

A chelating agent, also referred to as a chelating ligand or a chelant, is a ligand molecule that is either an ion or molecule and that bonds via coordinate covalent bonds to a central metal ion to produce a coordination complex, called a chelate complex. As used herein, a “chelating agent” is a Lewis base, i.e., the chelating agent contains at least at least two donor atoms in the same molecule capable of donating electrons to the metal cation. Preferred donor atoms are polar heteroatoms and include nitrogen, oxygen, and sulfur. The central metal is a Lewis acid, i.e., the central metal can accept pairs of electrons from the chelating agent. A chelating agent that bonds through two coordinating atoms is called bidentate; one that bonds through three is called tridentate, and so on.

A coordinate covalent bond is a covalent bond in which one atom (i.e., the donor atom) supplies both electrons. This type of bonding is different from a normal covalent bond in which two atoms each supply one electron. If the coordination complex carries a net charge, the complex is called a complex ion. Compounds that contain a coordination complex are called coordination compounds. Coordination compounds and complexes are distinct chemical species, for example, their properties and behavior are different from the metal ion and ligand from which they are composed.

The VES molecules can contain functional groups that are capable of acting as ligands, preferably as chelating ligands, by forming a coordinate covalent bond with the transition metal in the metal complex. The VES molecules can contain functional groups that comprise polar heteroatoms containing at least one unshared electron pair. Examples of suitable polar atoms that can contain unshared pair of electrons and are capable of forming a coordinate covalent bond with transition metal cations include nitrogen, oxygen, sulfur, and phosphorous. Examples of functional groups containing such polar heteroatoms include carboxylate groups, amino groups, alcohol groups, ether groups, a thiol group and any combination thereof in any proportion. In a preferred embodiment, the VES molecules contain more than one functional group that can form coordinate covalent bonds with a transition metal. In an embodiment, the polar surfactant head includes functional groups that can form coordinate covalent bonds with a transition metal ion.

It is discovered that VES molecules or pre-formed VES micelles can interact with transition metal coordination complexes in a variety of ways to form new structures with properties that would be expected for a cross-linked polymer networks. Examples of properties that are characteristic of cross-linked polymer networks include an increase in viscosity and viscoelastic behavior. Increased viscoelasticity may be measured by rheometric methods which measure G′ (elastic modulus), G″ (viscous or loss modulus) and phase angle θ. Increased viscoelasticity of a cross-linked polymer network includes an increase in G′, a decrease in G″, and a decrease in the G″/G′ ratio (referred to as tan θ). Without being limited by theory, the VES molecules can act as ligands and faun coordinate covalent bonds with the transition metal of the complexed metal cation. The VES molecules can act as mono-dentate ligands in forming the coordinate covalent bonds with the transition metal cation. A mono-dentate group, for example an alcohol group, an amino group or a thiol group, complexes with the metal cation through the polar atom. Alternately, VES molecules containing functional groups capable of functioning as ligands can form metal chelate bonds at the metal center. The VES molecules can also act as a multi-dentate ligand. A multi-dentate ligand contains more than two polar atoms having unshared pair of electrons on the ligand which can bind with the metal.

VES micelles can be cross-linked via complexation of VES molecules from different VES micelles at the transition metal center of a single cross-linking agent molecule. Alternately, cross-linked VES micelles may be foamed by ionic forces between the oppositely charged complexed transition metal and the VES molecules. For example, if the transition metal coordinated complex portion is cationic and VES surfactant molecules or micelles have anionic surfactant heads, two or more such micelle chains may be effectively cross-linked by the oppositely charged metal complex. Any gels formed by such interactions may be termed ionic gels.

A cross-linking agent is made up of cross-linking agent molecules. The cross-linking agent molecules can be the same or different. According to the invention, a cross-linking agent for the VES molecules includes cross-linking agent molecules having at least one complexed transition metal cation having a valence state of at least three. Examples of such complexed transition metal cations include hydroxycarboxylates, aminocarboxylates, trialkanolamine, amines, and/or beta-diketone complexes of iron (III), chromium (III), zirconium (IV), titanium (IV), and hafnium (IV), niobium (V), molybdenum (VI) and tungsten (VI). The number in the parenthesis represents the valence state, also referred to as the oxidation state or oxidation number of the metal in the complex. Specific examples of complexed transition metal cations include zirconium ammonium lactate acetate, zirconium lactate triethanolamine, zirconium carbonate, zirconium acetyl acetonate, zirconium malate, zirconium glycinate, and zirconium citrate. The complexing metal cations listed above presumably form coordination complexes with chelants, also referred to as chelating ligands, and allow the complexed metal ion to form chelated structures selectively. Such complexes are described in: U.S. Pat. No. 7,297,665, having for named inventors Phillip C. Harris and Stanley J. Heath, issued on Nov. 20, 2007; U.S. Pat. No. 7,345,013, having for named inventors Greig Fraser, issued on Mar. 18, 2008; U.S. Pat. No. 6,737,386, having for named inventors Ralph Moorehouse and Lester E. Matthews, issued on May 18, 2004; and U.S. Pat. No. 6,214,773, having for named inventors Phillip C. Harris, Stanley J. Heath, David M. Barrick, Ron J. Powell, Billy F. Slabaugh, Shane L. Milson, Gregory L. Tanaka, and Harold G. Walters, issued on Apr. 10, 2001, each of which is incorporated by reference herein in its entirety. If there is any conflict between a reference incorporated by reference and the present disclosure, the present disclosure will control. Examples of commercially available complexed metal cations include “CL-23”, “CL-40”, “CL-37”, and “CL-18” available from Halliburton Energy Services in Duncan, Okla.

The transition metal cation of the complexed metal complex is selected for being capable of cross-linking the VES micelles together to form a complexed metal cation-VES micelle network. The complexed metal cation can be in the form of: a salt of a cationic metal complex and a counter anion; an anionic metal complex and a counter cation (depending on the number of the complexed groups per metal and their charges); or a neutral complex. The counter anion can be inorganic or organic. Examples of suitable inorganic anions include an anion such as cyanate, thiocyanate, and oxychloride or an anion that is formed when a mineral acid is neutralized such as carbonate, bicarbonate, sulfate, bisulfate, chloride, bromide, and nitrate. Examples of suitable organic anions include a carboxylate ion such as an acetate, a propionate ion, or a sulfonate ion such as benzene sulfonate. Examples of counter cations include ammonium ions and alkali metal ions, such as sodium and potassium ions. When the complex is neutral or non-ionic, it can be either due to neutralization of the charge on the metal ion in the un-complexed state by the anionic charges on the ligand, or it can be due to the presence of equal amounts of cationic and anionic complexed metal components in the cross-linker composition. The latter situation can be a result of the presence of varying amounts of anionically-charged ligands that have complexed to the metal ion. The metal complex unit may have two or more transition metal ions connected by a bridging ligand, for example by one or more oxo (—O—) bridges. An oxo bridge refers to a metal-oxygen-metal bond in which two metal cations are bridged by an oxide ion.

According to one aspect of the invention, the complexed metal cation can comprise at least one ligand having at least one hydrophobic alkyl group. A suitable example of a hydrophobic alkyl group according to the invention is an alkyl group containing C14-C22 hydrocarbon units. The hydrophobic alkyl group may be bonded directly to the metal coordinating functional group, or via an intervening ethoxylated, propoxylated, or ethoxylated/propoxylated spacer group. To improve water solubility of such hydrophobic ligands, the molecules may contain an ethoxylated, propoxylated, or ethoxylated/propxylated spacer group between the hydrophobic alkyl group portion and the metal complexing functional group. Alternately, the molecules may be sulfonated to improve water solubility. Examples of ligands containing hydrophobic alkyl groups directly bonded to a coordinating group include alkylbenzene sulfonate salts, fatty acid salts, primary amines, hydroxyethyl alkylamines and primary alcohols containing the required carbon chain lengths. Examples of ethoxylated ligand molecules containing hydrophobic alkyl groups include ethoxylated alcohols, polyoxyethylene glyceryl monostearate, nonylphenylethoxylates, sorbitan monooleates, alkyl glycosides, sulfosuccinic acid esters, and the like. Preferred specific examples of commercially available materials include TWEEN 60, TWEEN 80, SPAN 60, and SPAN 80. The ratio of the number of hydrophobic alkyl groups per metal atom in the transition metal complex can be in the range of 0.5 to 4.

Water-soluble transition metal complexes comprising ligands having hydrophobic alkyl groups may be prepared by reacting the alkyl groups with a transition metal coordination complex by displacement of one or more ligands from the complex, or by reacting a precursor transition metal salt with ligands containing hydrophobic ligands. In a preferred coordination metal complex, a mixture of ligands containing at least one ligand having a hydrophobic alkyl group are reacted with a transition metal complex to form the coordination metal complex with the desired structure.

When the complexed transition metal comprises a ligand having a hydrophobic alkyl groups, the cross-linking interaction of the metal complex with VES micelles can be accomplished by incorporation of the hydrophobic alkyl groups into the micelles. The associative hydrophobic attractive forces between alkyl groups of the metal complex and those in the tails of the surfactant molecules contribute to improved elasticity and viscosity of the fluid composition.

The complexed transition metal may also initiate the formation of VES micelles by providing optimum ionic strength to the fluid composition, and thereafter cross-link the micelles. Alternately, the VES micelles may be pre-formed by the addition of a suitable material, for example salt, and then cross-linked with the cross-linking agent. The VES can also be in at least the critical micelle concentration in the fluid composition such that micelles are formed, and then the micelles can be cross-linked with the cross-linking agent.

The treatment fluid can contain other components including, but not limited to, salt, proppant, a breaker, a breaker aid, a co-surfactant, an oxygen scavenger, an alcohol, a scale inhibitor, a corrosion inhibitor, a fluid-loss additive, an oxidizer, a bactericide, a biocide, a microemulsion, and the like. The treatment fluid can also include a gas for foaming the fluid. If a breaker is included, then the breaker should be selected and in a sufficient concentration such that the viscosity of the treatment fluid, after it is introduced into a wellbore, is reduced to a desired viscosity. The term “break” (and its derivatives) as used herein refers to a reduction in the viscosity of the viscoelastic treatment fluid, e.g., by the breaking or reversing of the cross-links between molecules. No particular mechanism is implied by the term. Examples of suitable breakers include, but are not limited to, an alcohol, oil, a salt, cyclodextrin, and any combination thereof in any proportion.

### Preferred Embodiment of the Inventions

The invention is directed to methods for treating a portion of a well. The methods include the steps of: (A) forming a viscoelastic treatment fluid, wherein the treatment fluid comprises: (i) water; (ii) a viscoelastic surfactant (“VES”), wherein: (a) the VES comprises VES molecules having an alkyl group of greater than 14 carbon atoms; (b) the VES comprises VES molecules having at least one functional group selected from a carboxylate group, an amino group, an alcohol group, and an ether group; (c) the VES is soluble in the water; and (d) the VES is in the form of micelles; and (iii) a cross-linking agent for the VES micelles, wherein: (a) the cross-linking agent comprises cross-linking agent molecules having at least one complexed transition metal, wherein the transition metal has a valence state of at least three; and (b) the cross-linking agent is soluble in the water; and (B) introducing the treatment fluid into a portion of the well.

According to a second aspect of the invention, the methods include the steps of: (A) forming a viscoelastic treatment fluid, wherein the treatment fluid comprises: (i) water; (ii) a viscoelastic surfactant (“VES”), wherein: (a) the VES comprises VES molecules having both an alkyl group of greater than 14 carbon atoms and at least one functional group selected from the group consisting of a carboxylate group, an amino group, an alcohol group, and an ether group; (b) the VES is soluble in water; and (c) the VES is in the form of micelles; and (iii) a cross-linking agent for the VES molecules, wherein: (a) the cross-linking agent comprises cross-linking agent molecules having at least one complexed transition metal, wherein the transition metal has a valence state of at least three; and (b) the cross-linking agent is soluble in water; and (B) introducing the treatment fluid into a portion of the well.

The treatment fluid includes water. The water can be freshwater, brackish water, seawater, brine, and any combination thereof in any proportion. Preferably, the water is in a concentration of at least 50% by weight of the treatment fluid. If the treatment fluid is a heterogeneous fluid, then preferably the water is the external phase of the treatment fluid.

The treatment fluid includes a viscoelastic surfactant (VES). As used herein “soluble in water” means that at least 1 g of the VES dissolves in 1 L of water. The VES molecules can be cationic, anionic, zwitterionic, non-ionic, or any combination thereof in any proportion. The VES includes VES molecules having an alkyl group of greater than 14 carbons (C14). Preferably, the VES molecules include an alkyl group in the range of C16-C18.

The VES includes VES molecules having at least one functional group selected from a carboxylate group, an amino group, an alcohol group, and an ether group. The functional group can form a coordinate covalent bond with the transition metal of the complexed transition metal; or provide the charge type necessary for ionic bonding with the oppositely charged complexed transition metal. Preferably, the functional group is located on the hydrophilic head of the VES molecules. Preferably, the VES molecules include at least two functional groups selected from a carboxylate group, an amino group, an alcohol group, an ether group, and any combination thereof in any proportion. Preferably, the VES includes VES molecules having both an alkyl group of greater than 14 carbons (C 14) and at least one functional group selected from a carboxylate group, an amino group, an alcohol group, and an ether group. The VES molecules can contain head groups selected from the group consisting of cationic, anionic, zwitterionic, non-ionic, and any combination thereof in any proportion and a hydrophobic tail.

Some of the VES molecules can function as a ligand. If the VES molecules function as a ligand, then, preferably, the VES molecules include at least two of the functional groups. Preferably, the functional groups are capable of forming a chelate complex with the complexed transition metal.

The methods can further include the step of determinating a desired viscoelasticity for the treatment fluid. Preferably, the viscoelasticity of the treatment fluid is increased to the desired viscoelasticity before the step of introducing. Preferably, the VES is in a concentration at least sufficient to increase the viscoelasticity of the treatment fluid to the desired viscoelasticity. The VES can be in the critical micelle concentration, i.e., a concentration above which micelles are spontaneously formed. Preferably, the VES is in a concentration of at least 3% by weight of the water. More preferably, the VES is in a concentration in the range of 3% to 10% by weight of the water.

The treatment fluid includes a cross-linking agent for the VES. The cross-linking agent is soluble in water. As used herein “soluble in water” means that at least 1 g of cross-linking agent dissolves in 1 L of water. The cross-linking agent includes cross-linking agent molecules having at least one transition metal present in the form of coordination complex. In a preferred embodiment, the transition metal comprises suitable ligands coordinated to the metal ion to form a coordination complex. For example, it is preferable that the transition metal is not in the form of a simple salt which fails to have such suitable ligands for forming the coordination complex with the transition metal. In another embodiment according to the invention, the complexed transition metal can comprise at least one ligand having at least one hydrophobic alkyl group.

If some of the VES molecules function as a ligand, then, preferably, the transition metals in the complex are capable of forming a chelate complex with the VES molecules and are capable of forming a cross-linked network with the VES micelles. More preferably, the transition metal is capable of forming a chelate complex with the VES micelles.

The cross-linking agent molecules can have the same or different transition metals. Preferably, the transition metal is selected from the group consisting of chromium, iron, zirconium, titanium, hafnium, niobium, tungsten, and molybdenum, and any combination thereof in any proportion. More preferably, the transition metal is zirconium. If the transition metal is zirconium, then, preferably, the cross-linking agent is selected from the group consisting of zirconium (IV) triethanolamine glycolate, zirconium (IV) triethanolamine lactate, zirconium ammonium lactate acetate, and any combination thereof in any proportion. It is preferable that the transition metal complex is prepared in an aqueous solution, wherein the aqueous fluid comprises greater than 50% water. It is also preferred that when alcoholic solvents are used in the preparation of transition metal complexes, the final transition metal complex solution contains a water to alcohol volume ratio in the range of 10:1 to 1:1 prior to use.

Preferably, the cross-linking agent is in a concentration at least sufficient to increase the viscoelasticity of the treatment fluid to a desired viscoelasticity after cross-linking with the VES micelles. Preferably, the cross-linking agent is in a concentration of at least 0.15% by weight of the water. More preferably, the cross-linking agent is in a concentration in the range of 0.15% to 5.0% by weight of the water.

The treatment fluid can also include other components. In a preferred embodiment, the treatment composition also comprises a hydrophobically-modified, water-soluble polymer. Such polymers may enhance the viscoelasticity of the treatment fluid when used in combination with the VES and transition metal complex. The hydrophobically-modified polymers may be non-ionic, anionic, cationic or may contain both anionic and cationic groups. Examples of such polymers include hydrophobically-modified celluloses, hydroxyethyl celluloses, guar, and polyelectrolytes. Examples of hydrophobically-modified polyelectrolytes include polyacrylates, polyacrylamides, and poly(dimethylamioethylmethacrylate-co-acrylate) copolymers. The hydrophobic groups in such polymers may contain C7-C22 alkyl groups. An example of a commercially available hydrophobically-modified, non-ionic, water-soluble polymers is NATROSOL 330 Plus™, which is a hydrophobically-modified hydroxyethyl cellulose available from AQUALON Corporation, Wilmington, Del. An example of a commercially available hydrophobically-modified, water-soluble polyelectrolyte is HPT-1™, which is a hydrophobically-modified, partially hydrolyzed poly(dimethyaminoethylmethacrylate) available from Halliburton Energy Services, Duncan, Okla. According to one aspect of the invention, the hydrophobically-modified polymer comprises functional groups that can form coordinate covalent bonds to the transition metal in the transition metal complex. Examples of such functional groups include hydroxy groups, carboxylate groups, and amino groups.

In another aspect of the invention, the transition metal complex is mixed with and/reacted with the hydrophobically-modified, water-soluble polymer prior to contacting with the VES composition. Hydrophobically-modified, water-soluble polymers with suitable structures that interact with VES micelles through incorporation of the hydrophobic groups, and transition metal ion in the transition metal complex through formation of coordinate covalent bond, or less preferably through electrostatic interactions are preferred. The treatment fluid may also include proppant or gravel. Preferably, the treatment fluid also includes a breaker. The breaker can be selected from the group consisting of an alcohol, oil, a salt, fatty acids, pH changing buffers, bacteria, and any combination thereof in any proportion.

The methods can further include the step of determinating a desired viscoelasticity for the treatment fluid. Preferably, the viscoelasticity of the treatment fluid is increased to the desired viscoelasticity before the step of introducing. If the treatment fluid contains proppant or gravel, then, preferably, the desired viscoelasticity is sufficient to suspend the proppant or gravel in the treatment fluid. It is preferable that only two components are present in the treatment fluid that increases the viscoelasticity to the desired viscoelasticity, which are the VES and the cross-linking agent.

The step of introducing can be included in fracturing, gravel packing, stimulation, completion, and fluid loss control operations. The methods can also include the step of breaking the viscoelasticity of the treatment fluid after the portion of the well has been treated. The methods can also include the step of removing at least a portion of the broken treatment fluid.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a to b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

### EXAMPLES

The following is a list of surfactants that were tested in Examples 1 and 2: Miranol JS; Miranol Ultra C-32; Miranol Ultra C-37; Mirataine TM; Miranol JEM; Mirataine BET C-30; Mirataine BB; Miranol FBS; Miranol HMA; Miranol C2M; HC-2; and Mirataine C-32.

In Example 1, each of the above-referenced surfactants was tested individually to determine the viscoelastic properties of the resulting solution according to prior methods of forming viscoelastic fluids. First, the surfactant was added to water in a concentration in the range of about 3% to about 5% by weight of water to form a surfactant solution. Next, potassium chloride (KCl) was added to each of the surfactant solutions in a concentration of 2% by weight of the water. Each of the surfactant-salt solutions was tested by swirling the solution and looking for any recoil. Of the surfactants tested, the only one that produced a viscoelastic fluid was Mirataine TM, which is available from Rhodia, Inc. (Cranbury, N.J., U.S.A.).

In Example 2, each of the above-referenced surfactants was tested individually to determine the viscoelastic properties of the resulting solution according to the invention. First, the surfactant was added to water in a concentration in the range of about 3% -5% by weight of water to form a surfactant solution. Next, four different metal cross-linker solutions were added individually to each of the surfactant solutions. The metal cross-linker solutions were added in a concentration of about 1.5% by volume of the surfactant solution. The four metal cross-linker solutions were zirconium triethanolamine glycolate (two compositions with different reactivities A and B), zirconium ammonium lactate acetate (C), and zirconium triethanolamine lactate (D). Zirconium ammonium lactate acetate (C) and zirconium triethanolamine lactate (D) are aqueous solutions containing the dissolved complexes in water; whereas, the two zirconium triethanolamine glycolate complexes (A and B) are isopropanol solutions of the complexes containing no water. The complexes A and B are the same composition, but are processed differently such that A is more reactive than B. Each of the surfactant-metal cross-linker solutions was tested by swirling the solution and looking for any recoil. Of the surfactants tested, the only one which produced a viscoelastic fluid was Mirataine TM.

The surfactant Mirataine TM was then tested using varying concentrations of Mirataine with each of the four metal cross-linker solutions (A-D) in varying concentrations. Mirataine TM was tested using the same procedures described above. A “high” Mirataine TM concentration was a 1:16 dilution of the commercially available Mirataine TM in water. A “low” Mirataine TM concentration was a 1:33 dilution of Mirataine TM in water. A “high” metal cross-linker solution was a concentration of 15 gal of cross-linker to 1000 gal of water (1.5% by volume). A “low” metal cross-linker solution was a concentration of 1.7 gal of cross-linker to 1000 gal of water (0.17% by volume). Table 1 presents the results from these tests.

TABLE 1

| | | High Mirataine | High Mirataine | Low Mirataine |
|---|---|---|---|---|
| Compo- | Type of Cross-linker | High Cross-linker | Low Cross-linker | Low Cross-linker |
| sition # | solution | Concentration | Concentration | Concentration |
| 1 | Zirconium | No viscoelastic | Clear viscoelastic | Clear viscoelastic |
| | triethanolamine | fluid | fluid | fluid |
| | glycolate complex (A) | | | |
| 2 | Zirconium | Viscoelastic fluid | No viscoelastic | No viscoelastic |
| | triethanolamine lactate | | fluid | fluid |
| | complex (D) | | | |
| 3 | Zirconium | No viscoelastic | Clear viscoelastic | No viscoelastic |
| | triethanolamine | fluid | fluid | fluid |
| | glycolate complex (B) | | | |
| 4 | Zirconium ammonium | No viscoelastic | No viscoelastic | No viscoelastic |
| | lactate- acetate | fluid | fluid | fluid |
| | complex (C) | | | |

In Example 3, Mirataine TM was tested with zirconium oxychloride to determine the viscoelastic properties of the resulting solution. Two Mirataine TM solutions were prepared in water using a 1:16 and a 1:33 ratio of Mirataine TM to water. Zirconium oxychloride (Composition 5) was added to each of these solutions at a concentration of 45 gal of ZrOCl₂ per 1000 gal of water (4.5% by volume). At this concentration, the zirconium oxychloride would deliver more chloride ion than the cross-linker solutions used in Example 2. The solutions were tested by swirling the fluid and looking for recoil. Neither solution produced a viscoelastic fluid. Without being limited by theory, it is proposed that, in order for the transition metal to cross-link the VES, the metal needs to be in the complexed form for cross-linking with the VES micelles. The results with complexes A and B indicate that when higher amounts of the complexes were used, the alcohol solvent present in the complex solutions may be acting as a gel breaker.

In Example 4, rheological characterization of VES compositions of the present invention was done using Haake RS 150 instrument using parallel plate method. A testing program was written to subject VES fluids to an oscillatory frequency sweep between 0.1 to 10 Hz at a stress of 1 Pa, followed by an oscillatory stress sweep from 0.1 to 50 Pa at a frequency of 1 Hz, and finally to rotatory shear rate sweep from 0.1 to 100 sec⁻¹. The starting values observed in each rheogical characterization technique are listed below. The values observed at the lowest frequency during the frequency sweep experiments, at the lowest stress values during the stress sweep experiments, and the lowest shear rate during the shear rate sweep are listed in Table 2. In addition to the four zirconium complexes listed previously (A-D), two additional titanium complexes (E and F) were also tested. Complexes E and F contain triethanolamine as one of the ligands and isopropyl alcohol as the solvent, with complex F containing a higher level of isopropyl alcohol than complex E.

TABLE 2

| | Mirataine | | | | | |
|---|---|---|---|---|---|---|
| Compo- | TM (ml) 1:16 | Zr | Wt. % Zr | G′ (Pa) | Tan | Viscosity (Pa) |
| sition # | Dilution | Complex | complex | @ 0.1 Pa | δ | at 0.1 sec⁻¹ |
| 6 | 10 | — | — | Below | — | Below |
| | | | | measurable | | measurable |
| | | | | limit | | limits |
| 7 | 10 | A | 0.4 | 2.16 | 0.57 | 2.6 |
| 8 | 10 | A | 4.6 | No viscosification - No rheology | | |
| | | | | measurements | | |
| 9 | 10 | B | 0.4 | 3.74 | 0.26 | 4.8 |
| 10 | 10 | C | 0.4 | Precipitation - No Rheology Measurements | | |
| 11 | 10 | D | 0.4 | Precipitation - No Rheology Measurements | | |
| 12 | 10 | E | 0.2 | 1.60 | 0.78 | 1.9 |
| 13 | 10 | F | 0.2 | 1.60 | 0.77 | 1.8 |

The results in Table 2 show that zirconium and titanium complexes form viscoselastic fluids of elastic modulus (G′) greater than 1, and the resulting fluids are elastic dominant as indicated by tan δ values (G″/G′) less than unity. In Composition 8, excessive isopropyl alcohol from using large amounts of the complex is assumed to be acting as a viscosity breaker of the VES fluid.

In Example 5, pre-formed VES fluids were reacted with transition metal complexes C and D, and improvements to the viscoelasticity of the fluids was measured by using the rheological method described in Example 4. An increase in G′ values, a decrease in tan δ values and/or an increase in the viscosity of VES fluids due to cross-linking reactions with transition metal complexes is an indication of improved viscoelasticity of the fluids. The results are shown in Table 3 for viscoelastic fluids formed by addition of salt to a 1:16 Mirataine TM to deionized water solution.

TABLE 3

| Compo- | Miratame | % | Zr | Wt. % Zr | G′ (Pa) | Tan | Viscosity (Pa) |
|---|---|---|---|---|---|---|---|
| sition # | TM (ml) | KCl | Complex | Complex | @ 0.1 Pa | δ | at 0.1 sec⁻¹ |
| 14 | 10 | 1 | — | — | 4.02 | 0.32 | 4.6 |
| (Note) | 10 | 1 | C | 0.4 | 5.44 | 0.26 | 3.9 |
| 15 | 10 | 1 | D | 0.4 | 6.16 | 0.26 | 4.06 |
| 16 | 10 | 4 | — | — | 6.91 | 0.24 | 4.4 |

Note -
Heated to dissolve precipitate and cooled before running rheologies

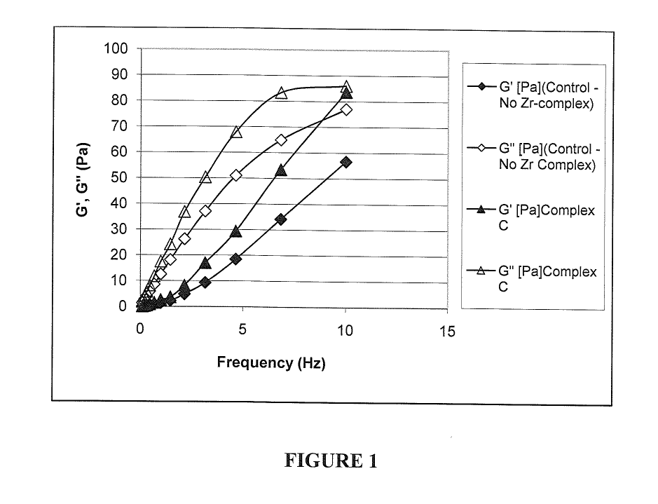

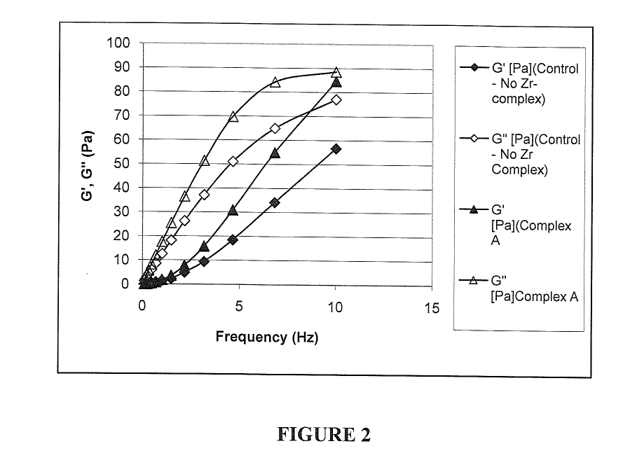

In Example 6, a viscoelastic fluid was formed by mixing a cetyl trimethylammonium bromide (CTAB) and water solution with sodium salicylate solution in a 1% sodium chloride solution at the concentrations shown in Table 4. Improvements to viscoelasticity (higher elastic modulus) of the fluids due to added zirconium complexes A and C can be seen in Table 4 and FIGS. 1 and 2. FIGS. 1 and 2 also show that the VES fluids containing the zirconium complexes become elasticity dominant at lower frequencies compared to the VES fluids containing no zirconium complexes.

TABLE 4

| | CTAB | Sodium | | | | | | |
|---|---|---|---|---|---|---|---|---|
| | (10% | Salicylate | | | | | | Viscosity |
| Compo- | Soln) | (10% soln) | % | Zr | Wt. % Zr | G′ (Pa) | Tan | (Pa) at |
| sition # | (ml) | (ml) | NaCl | Complex | Complex | @ 0.1 Pa | δ | 0.1 sec⁻¹ |
| 17 | 4 | 1.9 | 1 | — | — | 1.79 | 6.46 | 2.42 |
| 18 | 4 | 1.9 | 1 | A | 0.25 | 2.31 | 7.15 | 2.90 |
| 19 | 4 | 1.9 | 1 | C | 0.25 | 2.42 | 7.22 | 2.42 |

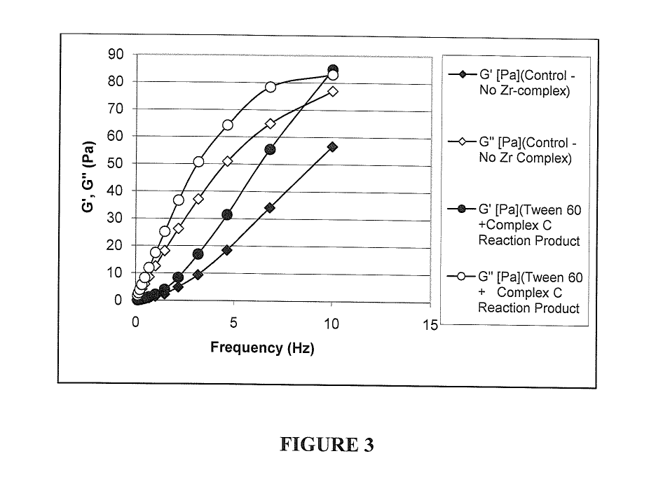

In Example 7, transition metal complexes containing hydrophobic ligands were synthesized and tested for their abilities to form and/or improve the rheological properties of VES fluids. Zirconium complex C was reacted with TWEEN 60 (polyoxyethylene sorbitan monooleate) by the addition of TWEEN 60 to zirconium complex C solution on a Zr to TWEEN 60 molar ratio of 1:1 and heated at 50° C. for 20 hrs. The modified zirconium complex solution was tested with the pre-formed VES fluid Composition 17 and the resulting fluid was rheologically characterized. The results are shown in FIG. 3. The results show that the fluid becomes elasticity dominant earlier than the control fluid. Zirconium complex A was reacted with either oleyl amine, hexadecyl amine, or dodecyl amine on a Zr to amine molar ratio of 1:1 by the addition of the amine to the zirconium complex A solution and heated at 50° C. for 20 hrs. Results from the testing of the CTAB and sodium salicylate solutions are presented in Table 5. Results from the testing of Mirataine TM solutions (1:16 dilution with water) are presented in Table 6.

TABLE 5

| | CTAB | Sodium | | | | | | |
|---|---|---|---|---|---|---|---|---|
| | (5% | Salicylate | | | | | | Viscosity |
| Compo- | Soln) | (10% soln) | % | Zr | Wt. % Zr | G′ (Pa) | Tan | (Pa) at |
| sition # | (ml) | (ml) | NaCl | Complex | Complex | @ 0.1 Pa | δ | 0.1 sec⁻¹ |
| 20 | 4 | 1 | 1 | — | — | 1.4 | 8.0 | 1.87 |
| 21 | 4 | 1 | 1 | A + Oleyl amine | 0.4 | 3.46 | 5.1 | 3.05 |
| | | | | product | | | | |

TABLE 6

| Compo- | | | | | Viscosity |
|---|---|---|---|---|---|
| sition | Zr | Wt. % Zr | G′ (Pa) | Tan | (Pa) at |
| # | Complex | Complex | @ 0.1 Pa | δ | 0.1 sec⁻¹ |
| 22 | A | 0.4 | 0.165 | 0.65 | 0.05 |
| 23 | A + dodecyl | 0.4 | 0.465 | 1.73 | 0.29 |
| | amine | | | | |
| 24 | A + hexadecyl | 0.4 | 1.35 | 0.845 | 1.15 |
| | amine | | | | |
| 25 | A + Oleyl amine | 0.4 | 2.50 | 0.458 | 2.96 |

The results in Tables 5 and 6 show that G′ values increase, tan δ and viscosity at low shear rates increase upon reaction with zirconium complexes reacted with hydrophobic ligands indicating improved viscoelasticity of the fluids. Fluids with improved viscoelasticities as exemplified by higher modulus of elasticity, lower tan δ values, and higher viscosities are expected to have improved particle suspension abilities.

In Example 8, use of hydrophobically-modified polymers in combination with transition metal complexes was investigated by using HPT-1 polyelectrolyte as a representative hydrophobically-modified polymer. Unless otherwise stated, a 1 ml solution of 1.2% HPT-1 and 0.04 grams of a zirconium complex solution were premixed and then added to 10 ml of a 1:16 dilution of Mirataine TM in water. The percentage of zirconium solution in the final composition was approximately 0.4% by weight. The rheological properties are presented in Table 7.

TABLE 7

| Compo- | Zr Complex | | | Viscosity |
|---|---|---|---|---|
| sition | Used in HPT-1 | G′ (Pa) | Tan | (Pa) at |
| # | combination | @ 0.1 Pa | δ | 0.1 sec⁻¹ |
| 26 | None-only HPT-1 | 2.60 | 0.341 | 28.0 |
| 27 | E | 8.95 | 0.060 | 63.6 |
| 28 | A (0.13%) | 7.75 | 0.129 | 54.0 |
| 29 | B (0.13%) | 6.73 | 0.190 | 55.1 |
| 30 | C | 4.63 | 0.213 | 11.0 |
| 31 | D | 7.71 | 0.120 | 23.7 |

The results in Table 7 show that significant improvement to rheological properties of VES fluids, and consequent potential improvement particle suspension and carrying ability of the resulting VES fluids can be realized by using transition metal complexes in combination with hydrophobically modified polymers and VES forming fluids.

1. A method for treating a portion of a well, the method comprising the steps of:
(A) forming a viscoelastic treatment fluid, wherein the treatment fluid comprises:
(i) water;
(ii) a viscoelastic surfactant (“VES”), wherein:
(a) the VES comprises VES molecules having an alkyl group of greater than 14 carbon atoms;
(b) the VES comprises VES molecules having at least one functional group selected from a carboxylate group, an amino group, an alcohol group, and an ether group;
(c) the VES is soluble in the water; and
(d) the VES is in the form of micelles; and
(iii) a cross-linking agent for the VES micelles, wherein:
(a) the cross-linking agent comprises cross-linking agent molecules having at least one complexed transition metal, wherein the transition metal has a valence state of at least three; and
(b) the cross-linking agent is soluble in the water; and
(B) introducing the treatment fluid into a portion of the well.

2. The method according to claim 1, wherein the water is in a concentration of at least 50% by weight of the treatment fluid.

3. The method according to claim 1, wherein the VES molecules contain a head group selected from the group consisting of cationic, anionic, zwitterionic, non-ionic, and any combination thereof in any proportion and a hydrophobic tail.

4. The method according to claim 1, wherein the VES comprises VES molecules having an alkyl group in the range of 16-18 carbon atoms.

5. The method according to claim 1, wherein the VES comprises VES molecules having at least two functional groups selected from the group consisting of a carboxylate group, an amino group, an alcohol group, an ether group, and any combination thereof in any proportion.

6. The method according to claim 5, wherein at least some of the VES molecules function as a ligand.

7. The method according to claim 6, wherein the transition metal has a valence state of at least four and is capable of forming a chelate complex with the VES molecules.

8. The method according to claim 1, wherein the complexed transition metal comprises at least one ligand having at least one hydrophobic alkyl group.

9. The method according to claim 1, further comprising the step of determinating a desired viscoelasticity for the treatment fluid.

10. The method according to claim 9, wherein the viscoelasticity of the treatment fluid is increased to the desired viscoelasticity before the step of introducing.

11. The method according to claim 10, wherein the VES is in a concentration at least sufficient to increase the viscoelasticity of the treatment fluid to the desired viscoelasticity.

12. The method according to claim 10, wherein the cross-linking agent is in a concentration at least sufficient to increase the viscoelasticity of the treatment fluid to the desired viscoelasticity after cross-linking with the VES micelles.

13. The method according to claim 10, wherein only two components are present in the treatment fluid that increases the viscoelasticity of the treatment fluid, which are the VES and the cross-linking agent.

14. The method according to claim 1, wherein the VES is in a concentration of at least 3% by weight of the water.

15. The method according to claim 1, wherein the transition metal has a valence state of at least four.

16. The method according to claim 1, wherein the transition metal is selected from the group consisting of chromium, iron, zirconium, titanium, hafnium, niobium, tungsten, molybdenum, and any combination thereof in any proportion.

17. The method according to claim 1, wherein the transition metal is zirconium.

18. The method according to claim 17, wherein the cross-linking agent is selected from the group consisting of zirconium triethanolamine glycolate, zirconium triethanolamine lactate, zirconium ammonium lactate acetate, and any combination thereof in any proportion.

19. The method according to claim 1, wherein the cross-linking agent is in a concentration of at least 0.15% by weight of the water.

20. A method for treating a portion of a well, the method comprising the steps of:
(A) forming a viscoelastic treatment fluid, wherein the treatment fluid comprises:
(i) water;
(ii) a viscoelastic surfactant (“VES”), wherein:
(a) the VES comprises VES molecules having both an alkyl group of greater than 14 carbon atoms and at least one functional group selected from the group consisting of a carboxylate group, an amino group, an alcohol group, and an ether group;
(b) the VES is soluble in water; and
(c) the VES is in the form of micelles; and
(iii) a cross-linking agent for the VES molecules, wherein:
(a) the cross-linking agent comprises cross-linking agent molecules having at least one complexed transition metal, wherein the transition metal has a valence state of at least three; and
(b) the cross-linking agent is soluble in water; and
(B) introducing the treatment fluid into a portion of the well.
